(19) United States
(12) Patent Application Publication
(10) Pub. No.: US 2016/0364533 A1
(43) Pub. Date: Dec. 15, 2016

(54) APPLICATION AND METHOD FOR ASSESSING AND SUPPORTING MEDICAL IMAGE INTERPRETATION COMPETENCIES

(71) Applicant: MEDVAL SYSTEMS INC., White Rock (CA)

(72) Inventors: Robert RAUSCHER, West Kelowna (CA); Hesham NABIH, West Vancouver (CA)

(21) Appl. No.: 15/112,949

(22) PCT Filed: Jan. 20, 2015
(86) PCT No.: PCT/CA2015/000035

§ 371 Date: Jul. 20, 2016

Related U.S. Application Data
(60) Provisional application No. 61/929,709, filed on Jan. 21, 2014.

(51) Int. Cl. G06F 19/00; G09B 19/24; G09B 5/12; G09B 7/00

(52) U.S. Cl. CPC G06F 19/327; G09B 7/00; G09B 19/24; G09B 5/12; G06F 19/321; G06F 19/328; G06F 19/3425

(57) ABSTRACT

An application and method to assess and optionally support the competency of a healthcare practitioner is provided. The method comprises: (i) providing a dynamic cloud computing application including: a plurality of medical images in a medical imaging viewer and a test, both for displaying on a visual display device; and analytics for analyzing a test result; (ii) selecting by the practitioner an assessment module; (iii) reviewing by the practitioner an at least one medical image in the assessment module; (iv) completing by the practitioner the test; (v) analysing the test result; and (vi) providing a score. No applications need to be installed to utilize the dynamic cloud computing application.

### CROSS REFERENCE TO RELATED APPLICATIONS

This application is related to, and claims the benefit of, U.S. Provisional Patent Application No. 61/929709, filed Jan. 21, 2014. The above-identified priority patent application is incorporated herein by reference in its entirety.

### FIELD

The present technology is an application and method that integrates a learning management system, a Digital Imaging and Communications in Medicine (DICOM) Viewer, data repositories, a collaboration system and performance analytics for use within the medical imaging profession. More specifically, the technology is a dynamic cloud computing application that integrates these components, allowing for multi-purposed deployment, without the need of installing additional applications on the user device.

### BACKGROUND

It is generally required that medical professionals continue with their education and provide proof of competency throughout their careers. The traditional approach has been a time-based model whereby credits are earned based on hours completed through self-learning and attendance at seminars. To date, there are few assessment tools to ensure continued competence of physicians throughout their careers.

The American College of Radiology offers certification to physicians in order to demonstrate competencies to payers and hospital credentialing committees. The certification process may require a physician to seek a mentor, pay training fees and travel expenses and loss days of salary while in training. More recently, computer-based systems have been developed to assist in continuing education and to assess competencies.

US Patent Publication No. 20130280686 discloses a medical training development system for development of medical training scenarios. The medical training development system comprises an event modules database with a plurality of pre-programmed event modules, a scenario programming system connected to the event modules database for accessing the event modules and for programming the medical training scenarios and a medical training scenario database. This system is meant to be used in conjunction with a mannequin.

In the related US Patent Publication No. 20130280685, a medical training development system for development of medical training scenarios is disclosed. The medical training development system comprises a repository with a plurality of pre-programmed event modules and pre-programmed medical training scenarios. A scenario programming system is connectable to the repository for accessing the event modules and the pre-programmed medical training scenarios for programming the medical training scenarios.

US Patent Publication No. 20130029300 discloses a method to assess the competency of a healthcare practitioner, comprising providing a learning object repository comprising a plurality of virtual objects including a plurality of virtual patients, wherein the learning object repository does not comprise a physical patient mannequin; and displaying on a visual display device a virtual clinical world comprising a plurality of virtual objects retrieved from said learning object repository. The method further includes selecting by a practitioner a virtual patient from said virtual clinical world, tracking patient interactions, tracking selected patient data, and generating an AssessMap reciting an assessment grid comprising a plurality of Performance Levels in combination with a plurality of categories for each Performance Level.

US Patent Publication No. 20100266998, which is the parent of the above application, discloses a method to assess the competency of a healthcare practitioner, wherein the method provides a learning object repository comprising a plurality of previously-created virtual objects, creates a first template and a second template by the second module, wherein the first template comprises one or more previously-defined learning objectives, and wherein the second template comprises one or more previously-defined competency assessments related to the one or more selected learning objectives. The method provides the first template and the second template to the learning object repository. The method displays on a visual display device a virtual clinical world comprising a plurality of virtual objects retrieved from the learning object repository. Further according to the method, a practitioner selects a virtual patient from the virtual clinical world, selects a series of interactions with the patient, and selects patient data. The method tracks the selected patient interactions, and the selected patient data.

US Patent Publication No. 20130275156 discloses educational systems and method employing confidential medical content. It includes an educational flow supported by a software system and/or software application wherein the flow presents the well known concepts of teach, test, and improve. In addition to training, the company website http://www.lifeimage.com discloses an Internet service for universal e-sharing of diagnostic imaging information. The service is designed to connect hospitals, radiology groups, and physicians, to their patients. lifeIMAGE® provides a system to securely deliver or receive patient imaging information. The objective of the IifeIMAGE® platform is to help avoid duplicate exams and eliminate unnecessary patient exposure to excessive radiation. It is a Web-based system in which imaging information is uploaded and downloaded.

US Patent Publication No. 20080059242 discloses a health care management system and method. In one embodiment, a health care management system comprises a database capable of receiving data; a processor operably connected to the database, the processor having and executing a program and operational to receive patient data associated with a patient, said patient data obtained from at least one patient visit; perform a multidimensional screening assessment of the patient information; generate data from the multidimensional screening assessment; store in the database at least part of the patient data and at least part of the multidimensional screening assessment data; and generate at least one report from the stored data in the database. In another embodiment, at least one member visit comprises one or more visits selected from the group consisting of a home visit, a provider visit, a phone consult, a pharmacy visit, and a family communication.

US Patent Publication No. 20050245232 discloses a method, system, and computer program software for an emergency management and response mission support platform for facilitating communication between a plurality of emergency response and management organizations. In one embodiment, the platform includes an incident management and response unit and a portal. The incident management and response unit coordinates information between a plurality of emergency management and response organizations and provides substantially real-time operational information, such as, for example, location of emergency personnel and assets from a plurality of organizations, emergency response plans, and evacuation plan analysis, and delivers this information to users via a portal which provides a user interface to view content provided by the incident management and response unit. The portal is typically a web portal and the information is provided to any web enabled device, either wireless or wired, connected to the network and authorized to receive the information provided by the platform.

There is a need for a dynamic cloud computing application that provides uniform, on-demand, scalable and reliable validation applications to support and assess the competency of medical professionals required to interpret medical images and to support them in interpretation of medical images. The system would preferably integrate the technologies of a learning management system, a content management system, a DICOM Viewer, repositories, collaboration tools that use dynamic screen sharing and performance analytics in a single robust system. It would be most advantageous if this could be in real time.

### SUMMARY

The present technology provides uniform, on-demand, scalable and reliable validation applications to support and assess the competency of medical professionals required to interpret medical images through the use of an integrated dynamic cloud computing application. The application integrates the technologies of a learning management system, a content management system, a DICOM Viewer, repositories, collaboration tools that use dynamic screen sharing and performance analytics in a single robust system. As it utilizes dynamic cloud computing, there is no need to install additional applications on the user device. More significantly, collaboration can be in real time.

In one embodiment, a method to assess and optionally support the competency of a healthcare practitioner is provided. The method comprises: (i) providing a dynamic cloud computing application including: a plurality of medical images in a medical imaging viewer; and a test, both for displaying on a visual display device; and an at least one analytic for analyzing a test result; (ii) selecting by the practitioner an assessment module; (iii) reviewing by the practitioner an at least one medical image in the assessment module; (iv) completing by the practitioner the test; (v) analysing the test result; and (vi) providing a score. No additional applications are required to be installed on the user device to utilize the dynamic cloud computing application.

The method may further comprise: providing, in the dynamic cloud computing application, a teaching module; and completing by the practitioner, the teaching module prior to completing the test.

The method may further comprise: collecting data from a plurality of tests from a plurality of healthcare practitioners; analyzing the data to provide a normal curve; and utilizing the normal curve to provide an adjusted grade.

In the method, the medical imaging viewer is preferably a Digital Imaging and Communications in Medicine Viewer (DICOM) viewer.

The method may further comprise: the healthcare practitioner viewing a video linked to the teaching module.

The method may further comprise the healthcare practitioner collaborating with an at least one other practitioner.

In the method the collaborating is preferably in real-time.

In another embodiment a system for supporting and assessing competency of a medical professional is provided, the system comprising: (i) a dynamic cloud computing application including: a Digital Imaging and Communications in Medicine Viewer (DICOM) viewer; and a learning management system with an at least one learning tool; (ii) an at least one user computing device for communication with the dynamic cloud computing application; and (iii) a server comprising or accessing a processor and a memory and in communication with the dynamic cloud computing application.

In the system the dynamic cloud computing application preferably further comprises an at least one DICOM image viewing tool.

In the system the dynamic cloud computing application preferably further comprises an at least one analytic.

In the system the dynamic cloud computing application preferably further comprises an at least one collaboration tool.

In another embodiment, a method for a collaboration in real-time between medical professionals, in reviewing an at least one Digital Imaging and Communications in Medicine (DICOM) image is provided, the method comprising: utilizing a dynamic cloud computing application including a Digital Imaging and Communications in Medicine Viewer (DICOM) viewer, an at least one image viewing tool and an at least one collaboration tool; and sharing the at least one DICOM image between a group of two or more medical professionals on the DICOM viewer.

The method may further comprise providing a share code to allow access to the collaboration.

In the method, the share code is preferably an encrypted time limited share code.

The method may further comprise identifying an area of interest on the at least one DICOM image.

The method may further comprise annotating the DICOM image with the collaboration tools, saving the DICOM image, and optionally, printing a hard copy of the DICOM image.

In yet another embodiment, a system for collaborative medical image analysis is provided, the system comprising: a dynamic cloud computing application including a medical image viewer and an at least one collaboration tool; a plurality of computing devices in communication with the dynamic cloud computing application; and a server comprising a processor and a memory, the server in communication with the dynamic cloud computing system.

In the system the dynamic cloud computing application further comprises an at least one image viewing tool.

In the system the memory includes instructions to instruct the processor to provide a share code to allow access once the share code has been entered.

In the system the medical image viewer is a zero footprint medical image viewer.

In the system the dynamic cloud computing application further includes an at least one analytic.

In the system, the medical image viewer, the at least one collaboration tool and the at least one image viewing tool are a DICOM medical image viewer, a DICOM collaboration tool and a DICOM image viewing tool.

A computer-readable storage medium for executing by a processor, the storage medium comprising one or more instructions to provide, in a cloud, a DICOM viewer and a plurality of modules for sharing, teaching, collaborating, assessing competencies, DICOM image collection and data analysis.

In yet another embodiment, a system for supporting and assessing competency of a medical professional is provided, the system comprising: (i) a cloud computing application including: a zero footprint Digital Imaging and Communications in Medicine Viewer (DICOM) viewer; and a learning management system with a plurality of learning tools; (ii) an at least one user computing device for communication with the cloud computing application; (iii) a server comprising or accessing a processor and a memory and in communication with the dynamic cloud computing application.

In the system the cloud computing application further comprises a plurality of DICOM image viewing tools.

In the system the cloud computing application further comprises a plurality of analytics.

In the system the cloud computing application further comprises a plurality of collaboration tools.

In the system the cloud computing application is a dynamic cloud computing application.

### FIGURES

FIG. 1 is a high-level exemplary block diagram of the application of the present technology.

FIG. 2 is a block diagram of an exemplary user's computing system.

FIG. 3 is a block diagram of the components of the application of the present technology.

FIG. 4 is a block diagram of the memory of the application.

FIG. 5 is a block diagram of the instruction modules of the memory of the application.

FIG. 6 is a block diagram of preparing a teaching session in the application.

FIG. 7 is block diagram of a learning session in the application.

FIG. 8 is a block diagram of a competency assessment in the application.

FIG. 9 is a block diagram of a collaboration in the application.

FIG. 10 is a block diagram of validating or determining reimbursement rates in the application.

FIG. 11 is a block diagram of assessing competency across a range of modalities.

### DESCRIPTION

Except as otherwise expressly provided, the following rules of interpretation apply to this specification (written description, claims and drawings): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open-ended terms (i.e., meaning “including, but not limited to,”) unless otherwise noted.

To the extent necessary to provide descriptive support, the subject matter and/or text of the appended claims is incorporated herein by reference in their entirety.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

DEFINITIONS

Dynamic cloud computing—in the context of the present technology, dynamic cloud computing is defined as cloud computing wherein the viewer is changed depending upon the user device configurations and the modality. Dynamic cloud computing dynamically allocates resource and data manipulation and generates user interfaces using a network of remote servers hosted on the Internet to store, manage, and process data.

Dynamic cloud computing application—in the context of the present technology, a dynamic cloud computing application is an entirely web-based application that uses web browsers for user interactions and adjusts the interface for the user device, the configuration of the user device and the modality. It does not require users to install additional applications or plug-ins to their browser, nor does it require the user to install an application on their computer to interface with a server application.

Cloud computing—in the context of the present technology, cloud computing is the use of computing resources (hardware and software) that are delivered as a service over a network (typically the Internet). This includes thin clients (those that require the user to install an application on their computer to interface with a server application) and web-based applications that require users to install additional applications or plug-ins to their browser.

DICOM Viewer—in the context of the present technology, a DICOM Viewer is a Digital Imaging and Communications in Medicine Viewer.

Zero footprint medical image viewer—in the context of the present technology, a zero footprint medical image viewer is a medical image viewer that it does not require installation of applications on the user device to operate.

TCP—in the context of the present technology, TCP is Transmission Control Protocol, a connection-oriented protocol over IP (Internet Protocol) (TCP/IP).

Medical images—in the context of the present technology, medical images are produced by radiography, including x-rays, magnetic resonance imaging (MRI), ultrasound, thermography, tomography, including computer tomography (CT), and the like, as would be known to one skilled in the art.

Note that network, world wide web and Internet are used interchangeably, each being means in which data can be exchanged between users.

### DETAILED DESCRIPTION

The system was developed to facilitate competency and proficiency assessments of medical professionals involved in the reading and interpretation of medical images for the purpose of decision-making in patient care and treatment. Additional uses for the tool include, but are not limited to, pre and post medical education including continuing education, personal self-assessment, access to cases for maintenance, supporting skill deficiencies and assessment of potential hires. Still further applications of the technology include, but are not limited to, collaboration between medical professionals, for example, to diagnose, determine treatments and treat patients.

The system is comprised of three main components that are all in the dynamic cloud computing application and two additional components that are in a cloud. Those in the dynamic cloud computing application are:

1. A dynamic cloud-based medical image viewer, preferably a DICOM viewer that displays digital images and tools. It includes a file format definition and a network communications protocol. The network communication protocol is an application protocol that uses TCP/IP to communicate between systems. DICOM files can be shared between two or more entities that are capable of viewing images and optionally, patient data, in DICOM format. The tools may support drawing, writing notes, and the like, to identify and discuss regions of interest in the data;

2. A learning management system with learning tools that are directly linked and interact with cases accessible through the DICOM viewer. The learning tools may include, but are not limited to patient history or teaching notes, links to videos, training lessons, exams, e-medical forms, feedback to users and quizzes. The learning system provides tools for evaluation and certification based on scoring algorithm; and

3. Collaboration tools that include screen sharing one-to-one and one-to-many, in real-time.

A user can utilize any or all of the components. Included in the application are: a content management system for, for example, but not limited to, adding course, images, teaching notes, quizzes, videos and the like; and system administration tools, including, but not limited to users management, online/offline payment system, monitoring of learning progress, test scores management and analysis.

The additional features of the dynamic cloud computing application that are in a cloud include:

1. A cloud-based medical image viewer, preferably a DICOM viewer, that displays digital images with tools. It includes a file format definition and a network communications protocol. The network communication protocol is an application protocol that uses TCP/IP to communicate between systems. Medical image files can be shared between two or more entities that are capable of viewing images, through the use of a monitor. The image data may include graphics, for example, circles, squares, lines and the like, and notes, to identify and explain regions of interest in the data; and

2. A learning management system with learning tools that are directly linked and interact with cases accessible in the medical image viewer. The learning tools may include, but not limited to patient history or teaching notes, links to videos, training lessons, quizzes, feedback to users and exams (and e-medical forms). The learning system provides tools for evaluation and certification based on scoring algorithm.

A user can utilize any or all of the components. Included in the application are: a content management system for, for example, but not limited to, adding course, images, teaching notes, quizzes, videos and the like; and system administration tools, including, but not limited to users management, online/offline payment system, monitoring of learning progress, test scores management and analysis.

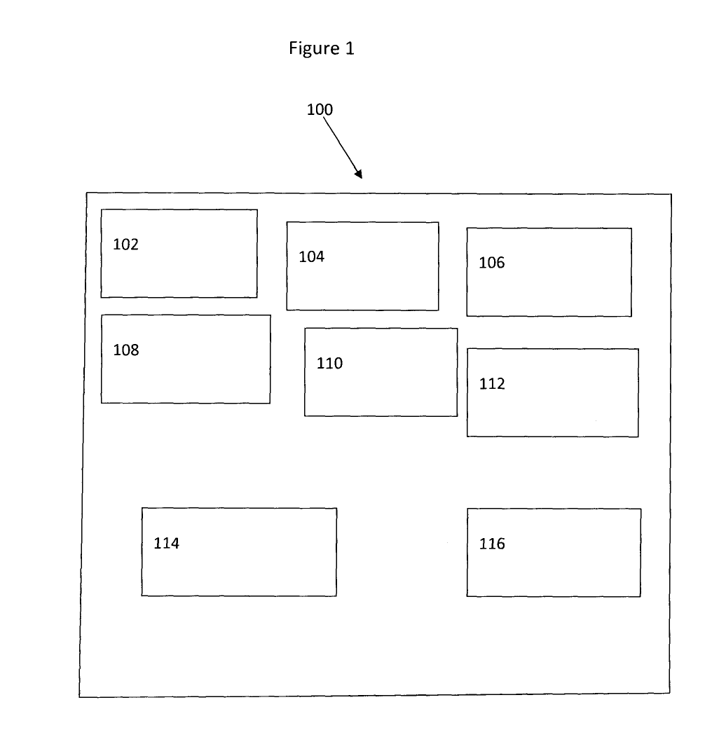

FIG. 1 illustrates a high-level exemplary block diagram of a dynamic cloud computing application for sharing medical images, generally referred to as 100. The application 100 includes modules for sharing 102, teaching 104, collaborating 106, assessing competencies 108, image collection 110 and data analysis 112. Alternatively or additionally, this application for sharing medical images 100 can be used by reimbursement specialists or payers to determine reimbursement rates 114, and regulators and accreditators to reinforce prudent medical practices 116.

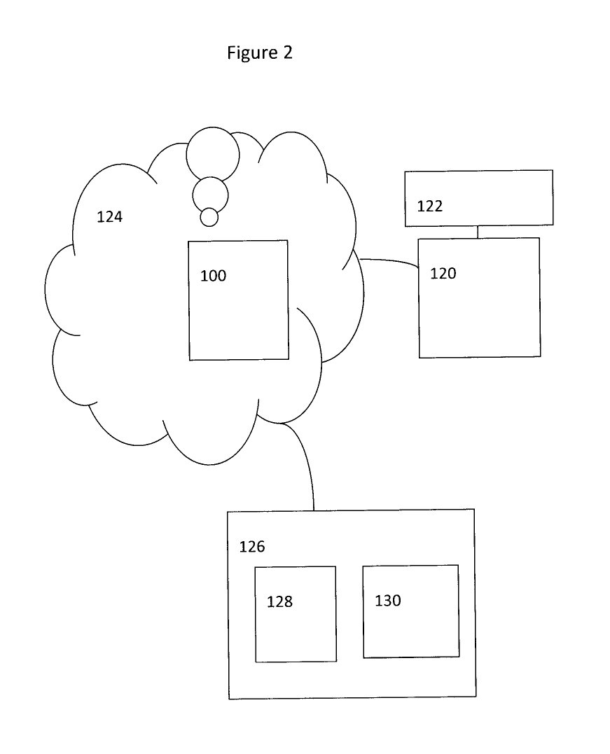

As shown in FIG. 2, one or more user computing devices 120 may be embodied in various forms such as, but not limited to a desktop computer system, laptop computer systems, any mobile computing and communicating devices (e.g., tablet computers or smartphones), server computer systems, a cluster of computer systems, or mainframe. The user computing device 120 includes or is connected to a user interface 122. The user computing devices 120 connect to the dynamic cloud computing application 100, which resides in a cloud 124. The cloud 124, in turn, is connected to a server 126 which has, or has access to a processor 128 and memory 130.

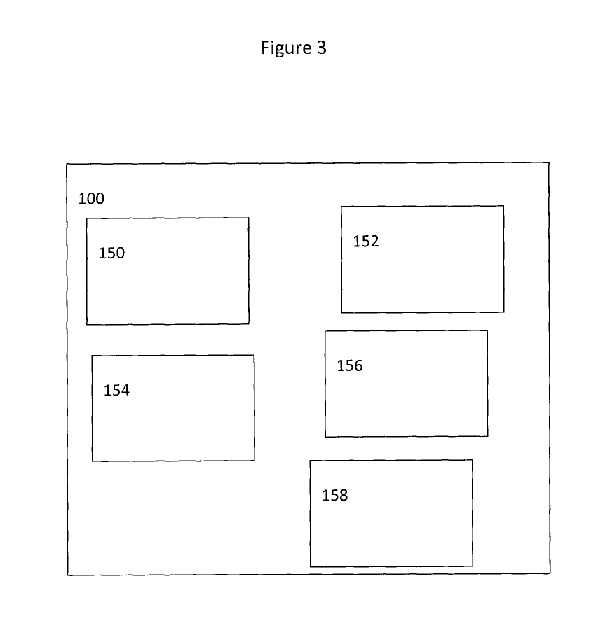

As shown in FIG. 3, the dynamic cloud computing application 100 includes an image viewer 150 which is preferably a DICOM viewer, image viewer tools 152, learning management software 154, learning tools 156 and collaboration tools 158.

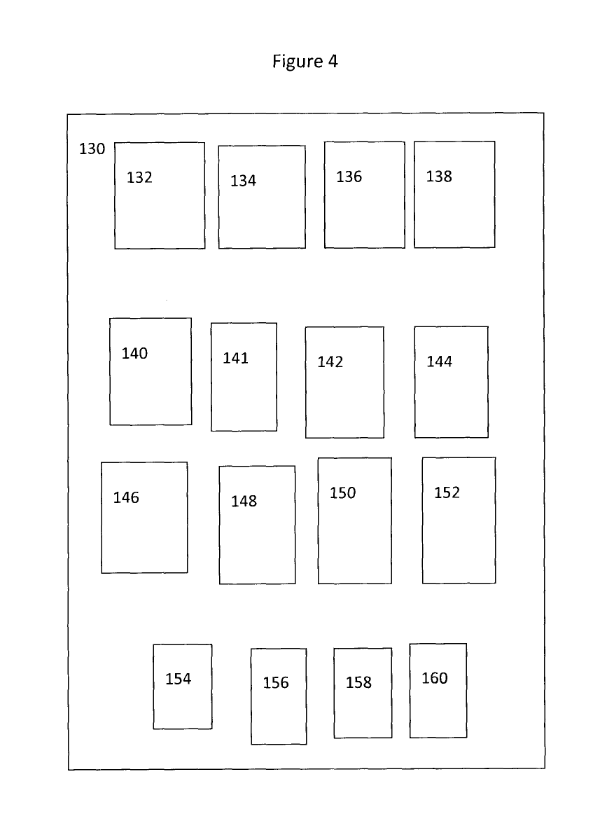

As shown in FIG. 4, the memory 130 includes a data repository 132 and instructions. The instructions include instructions for providing quizzes 134, marking user quizzes and providing marks 136, providing images 138, resizing images 140, arranging images 141, collecting data 142, analysing data 144, providing reports 146, providing tools 148, protecting patient data 150, building teaching sessions 152, providing webpage links 154, storing of analysed data 156, capturing of webpages 158 and extraction of webpage information 160.

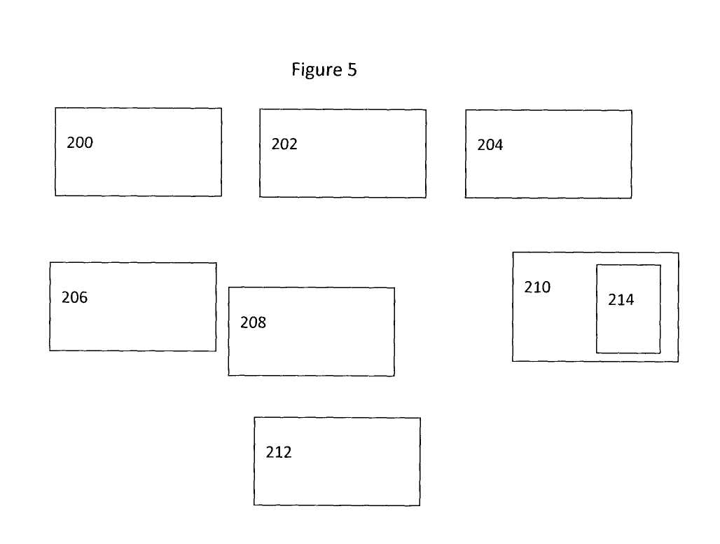

As shown in FIG. 5, the instructions 134-160 reside in modules, including a development module 200 for developing materials, a learning module 202, a collaboration module 204, a data collection module 206, a data extraction module 208, a data analysis module 210 and a reporting module 212. The data analysis module 210 includes scoring algorithms 214. The scoring algorithms can be used to provide data to adjudicators for determination of proficiency and competency, to medical professionals to rank the difficulty in diagnosis, to medical professionals to rank relative occurrence of a given condition, and to reimbursement specialists and regulators. These algorithms allow for adjusted grades i.e. rather than providing a raw score, the grade is reflective of the difficulty of the task and for example, fits the data to a normal curve.

### EXAMPLES

In all cases, it is preferably that the images are protected by firewalls and the like, and passwords and/or share codes are needed in order to access the images.

### Example 1

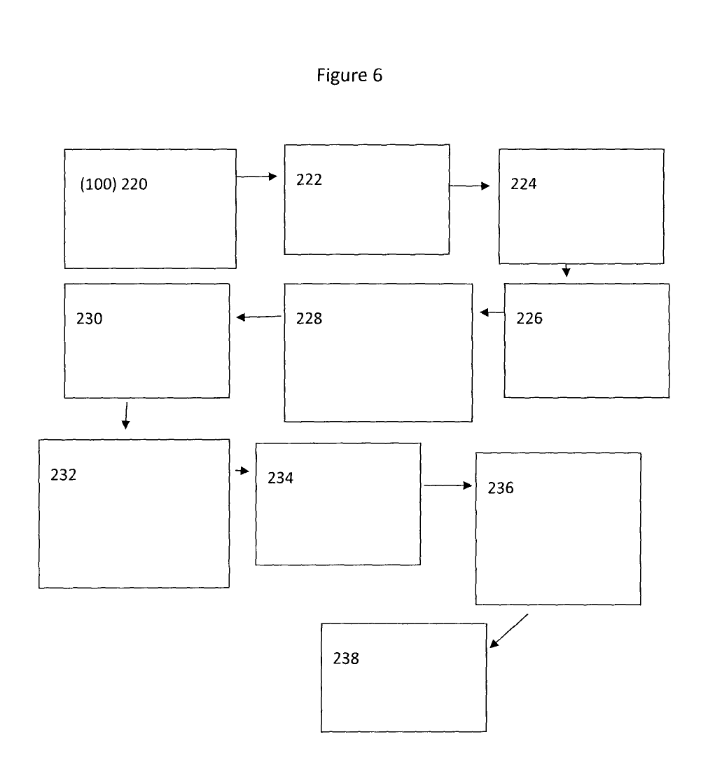

By way of example, a suitable exemplary method of preparing a teaching session is shown in FIG. 6. A teacher uploads 220 a DICOM image into the dynamic cloud computing application 100. The teacher is not required to download any software in order to use the dynamic cloud computing application. The DICOM image may be from, for example, but not limited to PACS (picture archiving and communications system), a compact disc (CD), the Internet, a flash drive, a local area network, a metropolitan area network or a wide area network (LAN, MAN or WAN, respectively) or the database within the dynamic cloud computing application. The teacher selects 222 a region of interest in the DICOM image and using the tools, identifies 224 that region by drawing 226 around the region. The dynamic cloud computing application stores 228 the DICOM image in the cloud. The teacher then prepares 230 teaching material that is one or more of a textual explanation, a second DICOM image demonstrating the difference between the first DICOM image and the second, a video, a test, for example, a quiz or exam and an answer key. The dynamic cloud computing application then associates 232 the DICOM image with the teaching material and stores 234 the DICOM image and teaching material in the cloud and in the processor-related memory. The dynamic cloud computing application then creates 236 a segment in the database for data collection 238.

### Example 2

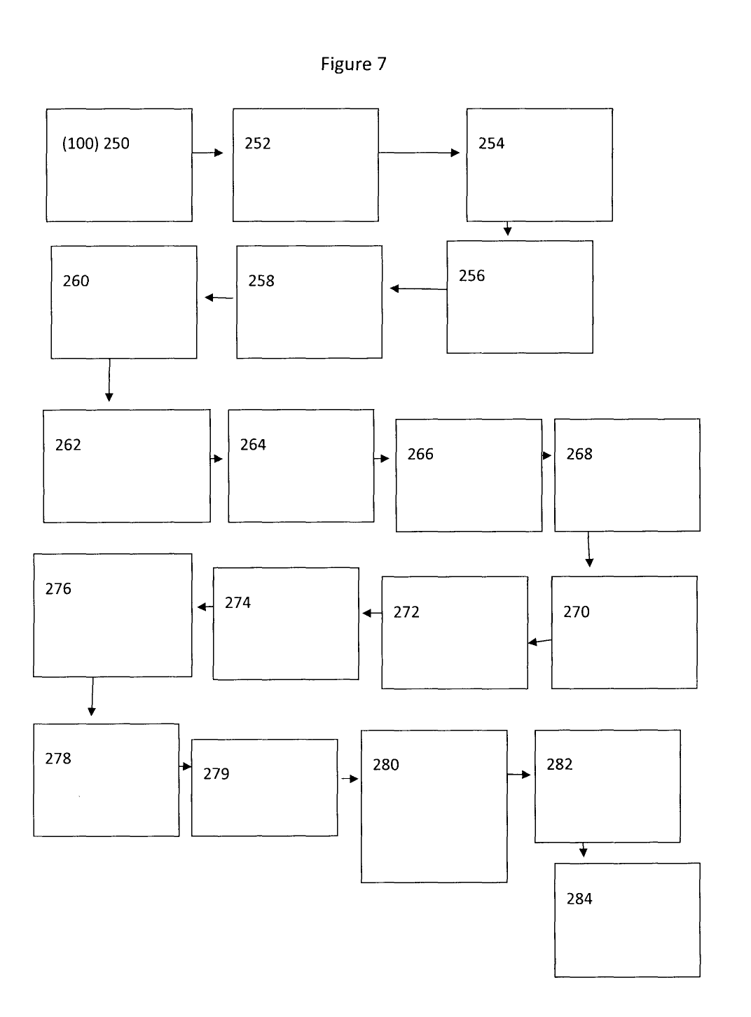

By way of example, a suitable exemplary method of learning is shown in FIG. 7. The user enters 250 the dynamic cloud computing application 100. The user is not required to download any software in order to use the dynamic cloud computing application—in other words, the viewer is a zero footprint viewer. The dynamic cloud computing application displays a dashboard 252, the user selects 254 the mammography teaching module and a menu drops down 256. The user selects 258 a learning session from the drop down menu. The DICOM viewer displays 260 a DICOM image that has one or more regions of interest identified. The user clicks 262 on the first region of interest and one or more of a textual explanation, a second image demonstrating the difference between the first DICOM image and the second, a video, and a drawing are provided 264 by the dynamic cloud computing application. Additionally, or alternatively, links may be provided 266. The user studies 268 the information and once they feel competent, they click 270 on a link or a drop down menu to reach the quiz or exam. The dynamic cloud computing application provides 272 the exam and marks 274 the exam or quiz, then provides 276 the result to the user. The data may be collected 278, merged with other data 279 and stored 280 in the database. If desired, the merged collected data may be further analyzed 282 by the dynamic cloud computing application, for example, to determine proficiency of a given group of health care professionals. A report may be rendered 284.

### Example 3

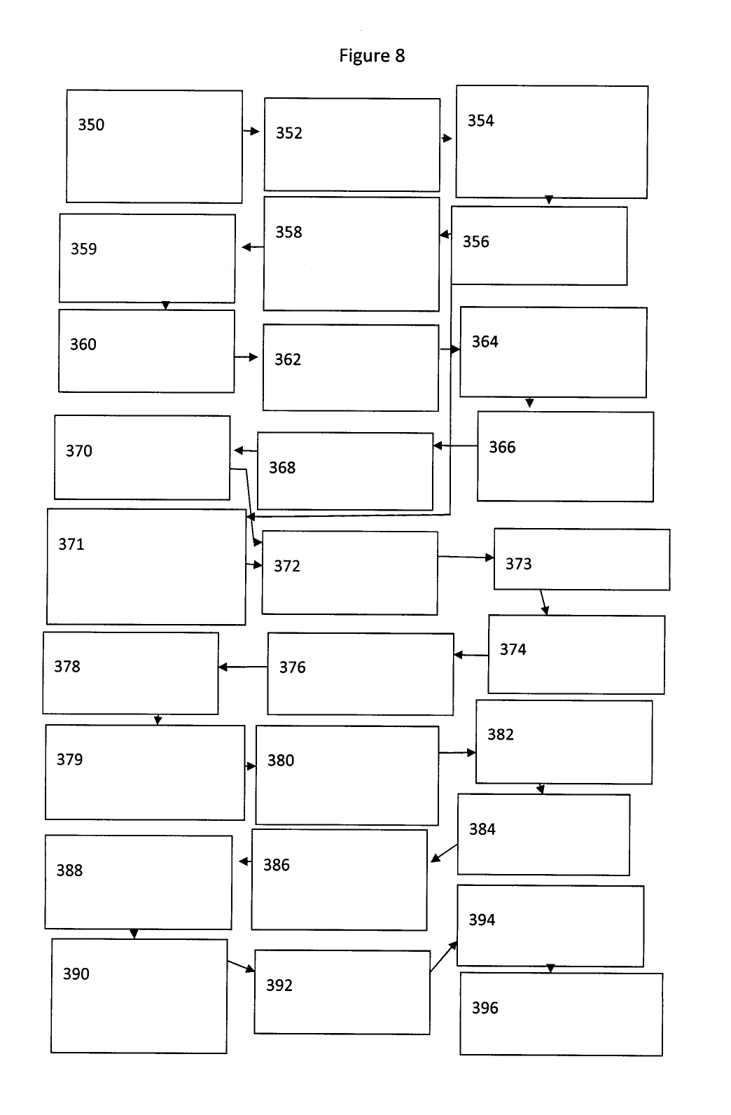

By way of example, a suitable exemplary method of assessing competency is shown in FIG. 8. A user is required to demonstrate competency with regard to CT scans of a diseased liver. The user enters 350 the dynamic cloud computing application 100. The user is not required to download any software in order to use the dynamic cloud computing application. The dynamic cloud computing application displays a dashboard 352, the user selects 354 the liver disease competency module and a menu drops down 356. The user selects 358 an assessment session from the drop down menu and is provided 359 with a teaching module. The DICOM viewer displays 360 a DICOM image that has one or more regions of interest identified. The user clicks 362 on the regions of interest and one or more of a textual explanation, a second DICOM image demonstrating the difference between the first DICOM image and the second, a video, and a drawing are provided 364 by the dynamic cloud computing application. Additionally, or alternatively, links may be provided 366. The user studies 368 the information and once they feel competent, they click 370 on a link or a drop down menu to reach the quiz or exam. Alternatively, the user may go 371 directly to the link or drop down menu to reach the testing material such as a quiz or exam without reviewing the teaching material. The dynamic cloud computing application provides 372 the exam and the user takes the exam 373. The dynamic cloud computing application marks 374 the exam or quiz, then provides 376 the result to the user and the adjudicator. The data may be collected 378 and merged 379 with stored data and stored 380 in the database. If desired, the collected data and/or merged data may be further analyzed 382 by the dynamic cloud computing application, for example, to determine proficiency of a given group of health care professionals. A report may be rendered 384. The analytics may also be used to access 386 scores for a given case, analyze the scores to determine statistically 388, the difficulty of the questions, analyze the scores to determine statistically 390, the difficulty of the case, develop a predictive model 392 for predicting score outcomes and develop a validation tool 394. As the database expands, the predictive models and validation tools will be used to improve 396 the teaching and competency testing.

### Example 4

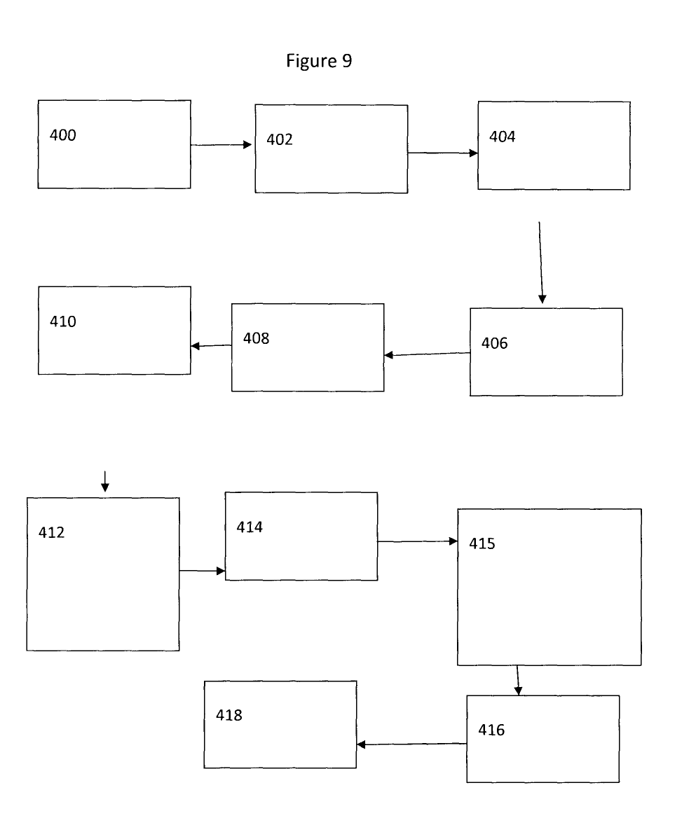

By way of example, a suitable exemplary method of collaborating is shown in FIG. 9. Two or more medical professionals want to collaborate on a difficult case. The first user enters 400 the dynamic cloud computing application 100 where they have previously stored the medical DICOM images. There are MRI and x-ray DICOM images to review. The first user selects 402 the appropriate files and invites 404 the other medical professionals to review the images. The dynamic cloud computing application displays a dashboard 406 to the other medical professionals. None of the medical professionals are required to download any software in order to use the dynamic cloud computing application. Using drop down menus or the dashboard, the other medical professionals are able to enter 408 the system. Note that the system limits access to registered users, and the other medical professionals preferably provide 410 a “share code” in order to view the DICOM images. Once the share code is entered, all the medical professionals are able to view 412 and manipulate 414 the DICOM images in real time. The share code, which is preferably a time limited, encrypted code is generated by the program code to allow one time access once the share code has been entered.

For example, but not limited to, one professional may want to enlarge the DICOM image, point to a specific location in the DICOM image, draw a box around a part of the DICOM image, pin point a location on the DICOM image, annotate the DICOM image, rotate the DICOM image, or book end the DICOM image with another DICOM image from another patient, healthy or otherwise. A second professional may also want to manipulate the DICOM image. A third may want to save and retrieve 415 a pdf of the DICOM image with notes to print 416. The hard copy is then loaded into the application for sharing 418. The share codes are preferably an encrypted time limited share code.

### Example 5

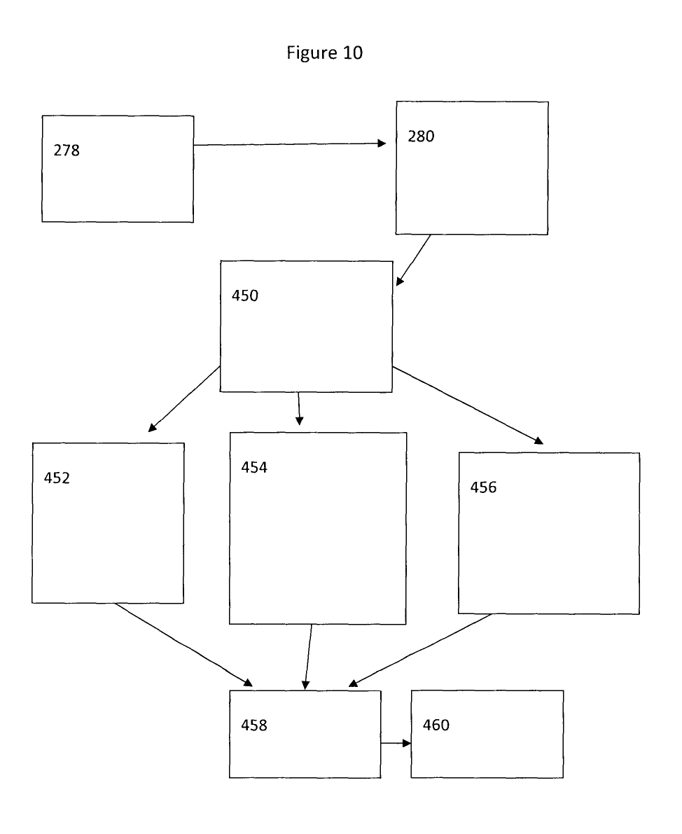

By way of example, a suitable exemplary method of validating or determining reimbursement rates is shown in FIG. 10. Reimbursement for medical procedures and services under public and private health insurance programs is controlled by CPT (Current Procedural Terminology) codes. A reimbursement specialist wants to determine whether the reimbursement rates for reading medical DICOM images are appropriate. A study is undertaken to compare the amount of time and the complexity of the analysis between reading an x-ray of a broken limb and reading an MRI of the brain of a patient suspected of suffering from Alzheimer's disease using data collected 278 and stored 280 in the database. The collected data include time stamps showing the amount of time spent reading the DICOM image. The data are extracted 450 from the memory of the dynamic cloud computing application. The data are analyzed 452 for reading time, number of professionals involved 454 and divergence of conclusions 456 using algorithms that present 458 the data as weighted means. A report is rendered 460.

### Example 6

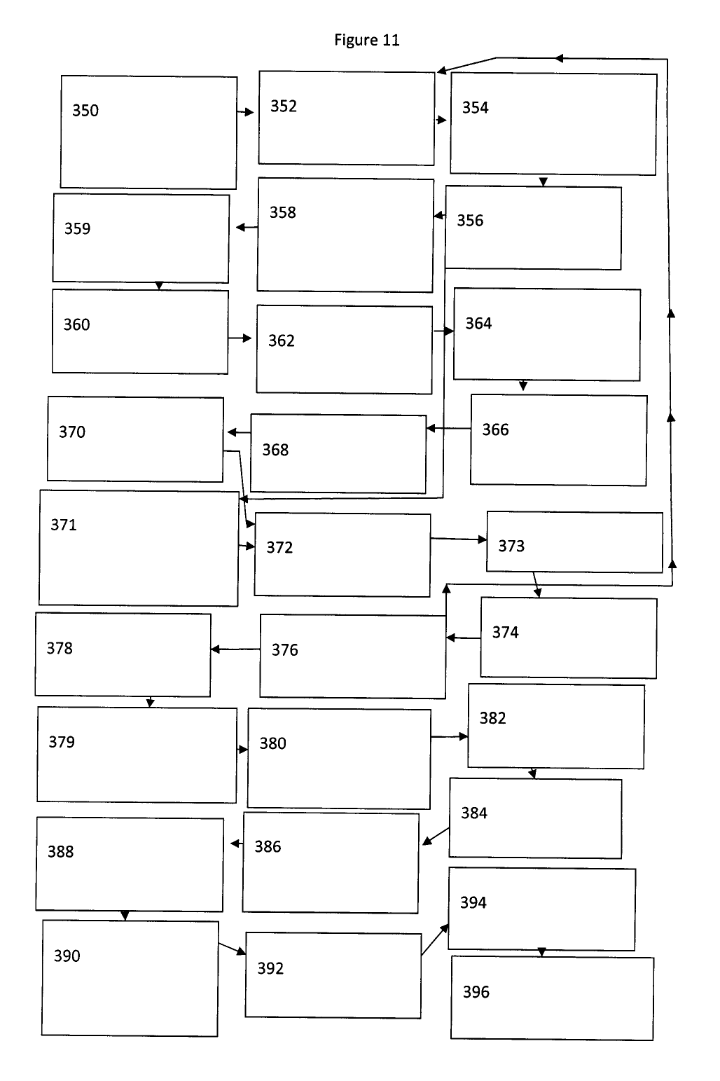

By way of example, a suitable exemplary method of assessing individuals across a combination of different modalities for privileging at a hospital is shown in FIG. 11. This method is also applicable to determining proficiency of internationally trained medical imagers for licensing/credentialing purposes or as part of a remediation strategy for medical imagers where concerns of competency exist or have been flagged.

A user is required to demonstrate competency with regard to MRI images of a cervical spine, CT scans of a diseased lung, and x-rays of a broken femur. The user enters 350 the dynamic cloud computing application 100. The user is not required to download any software in order to use the dynamic cloud computing application. The dynamic cloud computing application displays a dashboard 352, the user selects 354 the cervical spine competency module and a menu drops down 356. The user selects 358 an assessment session from the drop down menu and is provided 359 with a teaching module. The DICOM viewer displays 360 a DICOM image that has one or more regions of interest identified. The user clicks 362 on the regions of interest and one or more of a textual explanation, a second DICOM image demonstrating the difference between the first DICOM image and the second, a video, and a drawing are provided 364 by the dynamic cloud computing application. Additionally, or alternatively, links may be provided 366. The user studies 368 the information and once they feel competent, they click 370 on a link or a drop down menu to reach the quiz or exam. Alternatively, the user may go 371 directly to the link or drop down menu to reach the testing material such as a quiz or exam without reviewing the teaching material. The dynamic cloud computing application provides 372 the exam, which is randomized, and the user takes the exam 373. The dynamic cloud computing application marks 374 the exam or quiz, then provides 376 the result to the user and the adjudicator. The user then returns to the dashboard 352 and selects another competency module. The process is repeated until all the modules have been tested. The data may be collected 378 and merged 379 with stored data and stored 380 in the database. If desired, the collected data and/or merged data may be further analyzed 382 and stored 380 in the database. The collected data may be further analyzed 382 by the dynamic cloud computing application, for example, to determine proficiency of a given group of health care professionals. A report may be rendered 384. The analytics may also be used to access 386 scores for a given case, analyze the scores to determine statistically 388, the difficulty of the questions, analyze the scores to determine statistically 390, the difficulty of the case, develop a predictive model 392 for predicting score outcomes and develop a validation tool 394. As the database expands, the predictive models and validation tools will be used to improve 396 the teaching and competency testing.

All methods described herein can be performed in any suitable order unless otherwise indicated herein or otherwise clearly contradicted by context. The use of any and all examples, or exemplary language (e.g., “such as”) provided herein, is intended merely to better illuminate the example embodiments and does not pose a limitation on the scope of the claimed invention unless otherwise claimed. No language in the specification should be construed as indicating any non-claimed element as essential.

Advantages of the exemplary embodiments described herein may be realized and attained by means of the instrumentalities and combinations particularly pointed out in this written description. It is to be understood that the foregoing general description and detailed description are exemplary and explanatory only and are not restrictive of the claims below. While example embodiments have been described in detail, the foregoing description is in all aspects illustrative and not restrictive. It is understood that numerous other modifications and variations can be devised without departing from the scope of the example embodiment.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize, or be able to ascertain using no more than routine experimentation, many equivalents to the specific example embodiments specifically described herein. Such equivalents are intended to be encompassed in the scope of the claims, if appended hereto or subsequently filed.

1. A method to determine reimbursement rates, and support the competency of a healthcare practitioner, comprising: (i) providing a dynamic cloud computing application including: a plurality of medical images in a medical imaging viewer and a test, both for displaying on a visual display device; and an at least one analytic for analyzing a test result; (ii) selecting, by a plurality of healthcare practitioners, an assessment module; (iii) reviewing, by the plurality of healthcare practitioners, an at least one medical image in the assessment module; (iv) completing, by the plurality of healthcare practitioners, the test; (v) analysing the test results to provide a data set; (vi) and analyzing the data set to determine reimbursement rates.

2. The method of claim 1, further comprising collecting and analyzing a reading time taken by each healthcare practitioner to further determine reimbursement rates.

3. The method of claim 2, further comprising providing a score to an at least one healthcare practitioner, thereby assessing the competency of the at least one healthcare practitioner.

4. The method of claim 3, further comprising: utilizing a normal curve of the data set to provide an adjusted score.

5. The method of claim 4, further comprising collecting and comparing a plurality of data sets for a plurality of conditions and ranking a relative occurrence of a condition to further determine reimbursement rates.

6. The method of claim 5, wherein the medical imaging viewer is a Digital Imaging and Communications in Medicine Viewer (DICOM) viewer.

7. The method of claim 6, further comprising providing, in the dynamic cloud computing application, a learning module; and completing by the at least one healthcare practitioner, the learning module prior to completing the test.

8. The method of claim 7, further comprising: the at least one healthcare practitioner viewing a video linked to the learning module.

9. The method of claim 8, further comprising the at least one healthcare practitioner collaborating with an at least one other healthcare practitioner.

10. The method of claim 9, wherein the collaborating is in real-time.

11. A system for supporting and assessing competency of a medical professional, the system comprising: (i) an integrated dynamic cloud computing application including: a Digital Imaging and Communications in Medicine Viewer (DICOM) viewer; a learning management system with an at least one learning tool, a content management system with an at least one teaching tool, an at least one data repository, an at least one collaboration tool that uses dynamic screen sharing and an at least one performance analytic; (ii) an at least one user computing device for communication with the dynamic cloud computing application; and (iii) a server comprising or accessing a processor and a memory and in communication with the dynamic cloud computing application.

12. The system of claim 11, wherein the dynamic cloud computing application further comprises an at least one DICOM image viewing tool.

13. The system of claim 12, wherein the at least one performance analytic includes a plurality of scoring instructions for at least one of determining proficiency and competency, ranking difficulty of a diagnosis and ranking a relative occurrence of a condition.

14. An integrated method for use in medicine, the method including teaching, learning, collaborating, collecting data, analysing data, assessing competencies, determining reimbursement rates and developing predictive models, the method utilizing a dynamic cloud computing application including a Digital Imaging and Communications in Medicine Viewer (DICOM) viewer, an at least one teaching tool, an at least one learning tool, an at least one image viewing tool, an at least one collaboration tool, and an at least one analytic, thereby providing an integrated method for use in medicine.

15. A computer-readable storage medium for executing by a processor, the storage medium comprising one or more instructions to provide, in a cloud, a DICOM viewer and a plurality of modules for developing teaching materials, storing teaching materials, teaching with the stored teaching materials, collaborating, data collection, assessing competencies, DICOM image collection, data extraction, data analysis and determining reimbursement rates.

16-17. (canceled)

18. The computer-readable storage medium of claim 15, wherein the data analysis module is configured for developing an at a least one predictive model.

19. The computer-readable storage medium of claim 18, wherein the data analysis module is configured for developing an at least one validation tool.

20. A system for supporting and assessing competency of a medical professional, the system comprising: (i) a cloud computing application including: a zero footprint Digital Imaging and Communications in Medicine Viewer (DICOM) viewer; a content management system and a learning management system with a plurality of learning tools; (ii) an at least one user computing device for communication with the cloud computing application; (iii) a server comprising or accessing a processor and a memory and in communication with the dynamic cloud computing application.

21. The system of claim 20, wherein the cloud computing application further comprises an at least one system administration tool.

22. The system of claim 21, wherein the at least one system administration tool includes an online/offline payment system.

23. The system of claim 22, wherein the cloud computing application further comprises a plurality of analytics.

24. The system of claim 23, wherein the plurality of analytics include predictive modeling.

25. The system of claim 24, wherein the plurality of analytics include data validation.

26.-28. (canceled)
